(19) United States
(12) Patent Application Publication
(10) Pub. No.: US 2016/0347599 A1
(43) Pub. Date: Dec. 1, 2016

(54) WATER DISPENSER AND DISPENSER TRAY FOR WATER DISPENSER

(71) Applicant: KABUSHIKI KAISHA COSMO LIFE, Kakogawa-shi, Hyogo (JP)

(72) Inventor: Shingo ARAKAWA, Hyogo (JP)

(21) Appl. No.: 15/113,882

(22) PCT Filed: Feb. 25, 2014
(86) PCT No.: PCT/JP2014/054504

§ 371 Date: Jul. 25, 2016

(30) Foreign Application Priority Data
Feb. 7, 2014 (JP) 2014-022186

(51) Int. Cl. B67D 3/00; A47L 11/40

(52) U.S. Cl. CPC B67D 3/0038; B67D 3/0009; B67D 3/0022; B67D 3/0035; B67D 3/0093; A47L 11/4091; A47L 11/4011; A47L 11/4013; A47L 11/4005; A47L 2201/022; A47L 2201/04

(57) ABSTRACT

A water dispenser is provided which is, if water leakage should occur, capable of detecting such water leakage at an early stage. The water dispenser includes a dispenser tray disposed between the housing and the floor surface and vertically separating the housing from the floor surface. The dispenser tray includes a dispenser support surface on which the housing is supported, a peripheral wall surrounding the dispenser support surface, and a water leakage indicator disposed in a region surrounded by the peripheral wall, and configured to change between a water leakage alarm state and a non-water-leakage-alarm state depending on whether or not there is water.

### TECHNICAL FIELD

This invention relates to a water dispenser and a dispenser tray for the water dispenser.

### BACKGROUND ART

While older water dispensers were mainly used in offices and hospitals, with growing interest in safety of water and health, water dispensers are now increasing used in households too. Water dispensers typically include a housing, a cold water tank received in the housing, a cooling device for cooling drinking water in the cold water tank, and a cold water cock for dispensing drinking water in the cold water to outside, whereby tasty drinking water can be used at any time simply by operating the cold water cock (see e.g., the below-identified Patent document 1).

### PRIOR ART DOCUMENT(S)

### Patent Document(s)

Patent document 1: JP Patent Publication 2011-046446A

### SUMMARY OF THE INVENTION

### Object of the Invention

In many cases, water dispensers are placed on floor (such as wood floor) surfaces. If water should leak from a water dispenser, and reach the floor surface, this could cause corrosion and/or discoloration of the floor surface. Especially if water leaks from the housing of the water dispenser 1 at a slow rate (such as if a trace amount of water oozes out), leaked water is less likely to be visually recognized, so that it tends to take a long time until water leakage is detected, which in turn tends to cause e.g., corrosion of the floor surface.

An object of the present invention is to provide a water dispenser which is, if water leakage should occur, capable of detecting such water leakage at an early stage.

### Means for Achieving the Object

In order to achieve this object, the present invention provides a water dispenser comprising a housing configured to be arranged over a floor surface, a cold water tank received in the housing, a cooling device for cooling drinking water in the cold water tank, a cold water cock for dispensing drinking water in the cold water tank to outside, and a dispenser tray disposed between the housing and the floor space and vertically separating the housing from the floor surface, wherein the dispenser tray comprises a dispenser support surface on which the housing is supported, a peripheral wall surrounding the dispenser support surface, and a water leakage indicator disposed in a region surrounded by the peripheral wall, and configured to change between a water leakage alarm state and a non-water-leakage-alarm state depending on whether or not there is water.

With this arrangement, if water should leak, the dispenser tray, provided between the housing and the floor surface to separate the housing from the floor surface, receives water, while the water leakage indicator, provided on the dispenser tray, changes to the water leakage alarm state, water leakage can be detected at an early stage.

Preferably, the dispenser tray further comprises a water collecting groove extending between the dispenser support surface and the peripheral wall, along the peripheral wall, and the water leakage indicator communicates with the water collecting groove.

With this arrangement, water on the dispenser tray can more easily reach the water leakage indicator while passing through the water collecting groove, which makes it possible to detect water leakage at an early stage.

Preferably, the water collecting groove is inclined such that the height of the water collecting groove gradually decreases toward the water leakage indicator.

With this arrangement, water collecting in the water collecting groove is guided to the water leakage indicator due to the inclination of the water collecting groove. This allows the water leakage indicator to change to the water leakage alarm state while the amount of water leakage is still small, which in turn makes it possible to detect water leakage at an early stage.

The dispenser tray may further comprise support legs extending downwardly from positions outside of the dispenser support surface and contacting the floor surface.

If such support legs are used, the water leakage indicator may include a float receiving recess which opens to the top surface of the dispenser tray and extends into one of the support legs; and a water detecting float inserted in the float receiving recess such that when water enters the float receiving recess, the water detecting float rises due to buoyancy of the water in the float receiving recess, wherein the water detecting float has a portion arranged to protrude from the float receiving recess and be exposed to outside when the water detecting float rises due to the buoyancy of the water in the float receiving recess, this portion having a water leakage alarm color.

With this arrangement, since the interior space of one of the support legs of the dispenser tray is used to receive the water detecting float, it is possible to increase the lengths of the water detecting float, thus increasing the distance by which the water detecting float rises due to the buoyancy of water. This increases the length of the portion of the water detecting float protruding from the float receiving recess when the water detecting float has risen due to the buoyancy of water, thus making it possible to reliably notify users of water leakage. Also, compared to electric water leakage indicators, this water leakage indicator is simple in structure and thus is less likely to fail, and operates reliably.

Alternatively, the water leakage indicator may include a float receiving recess which opens to the top surface of the dispenser tray and extends into one of the support legs; a water absorbent polymer member made of a water absorbent polymer and received in the float receiving recess so as to be expandable by absorbing water; and a water detecting float inserted in the float receiving recess such that when water enters the float receiving recess, the water detecting float is pushed up by the water absorbent polymer member, wherein the water detecting float has a portion arranged to protrude from the float receiving recess and be exposed to outside when the water detecting float is pushed up by the water absorbent polymer member, this portion having a water leakage alarm color.

With this arrangement, since the interior space of one of the support legs of the dispenser tray is used to receive the water detecting float, it is possible to increase the lengths of the water detecting float, thus increasing the distance by which the water detecting float is pushed up by the water absorbent polymer member. Also, since the water detecting float is raised using the expansion force of the water absorbent polymer member, it is possible to raise the water detecting float by a longer distance than when raising the water detecting float using the buoyancy of water. Thus, when the water detecting float is raised by the water absorbent polymer member, the water detecting float protrudes by a long distance from the float receiving recess, so that the water leakage indicator can reliably notify user of water leakage. Also, compared to electric water leakage indicators, this water leakage indicator is simple in structure and thus is less likely to fail, and operates reliably.

The support legs may have lengths larger than the height of a self-propelled cleaning robot so that the support legs define, between the dispenser support surface and the floor surface, a robot receiving space that the self-propelled cleaning robot enters and exists while being self-propelled.

With this arrangement, it is possible to effectively increase the length of the water detecting float, which is received in one of the support leg of the dispenser tray. Since the self-propelled cleaning robot is received between the dispenser support surface and the floor surface, the water dispenser and the self-propelled cleaning robot take up, in combination, smaller space.

The dispenser tray and the housing are preferably fastened to each other by a fastening means so as to be immovable relative to each other.

With this arrangement, it is possible to effectively prevent the fall of the housing of the water dispenser even if the housing of the water dispenser is hit by a person or during an earthquake.

From another aspect of the present invention, there is provided a dispenser tray which can be used with the above-described water dispenser, the dispenser tray comprising a dispenser support surface on which the housing of the water dispenser can be supported, a peripheral wall surrounding the dispenser support surface, a water leakage indicator disposed in a region surrounded by the peripheral wall, and configured to change between a water leakage alarm state and a non-water-leakage-alarm state depending on whether or not there is water.

### Advantages of the Invention

Since the water dispenser according to the present invention is configured such that if water should leak, the dispenser tray, provided between the housing and the floor surface to separate the housing from the floor surface, receives water, while the water leakage indicator, provided on the dispenser tray, changes to the water leakage alarm state, water leakage can be detected at an early stage.

### BRIEF DESCRIPTION OF THE DRAWINGS

FIG. 1 is a front view of a water dispenser embodying the present invention.

FIG. 2 is a sectional view taken along line II-II of FIG. 1.

FIG. 3 is an enlarged sectional view of and around a dispenser tray of

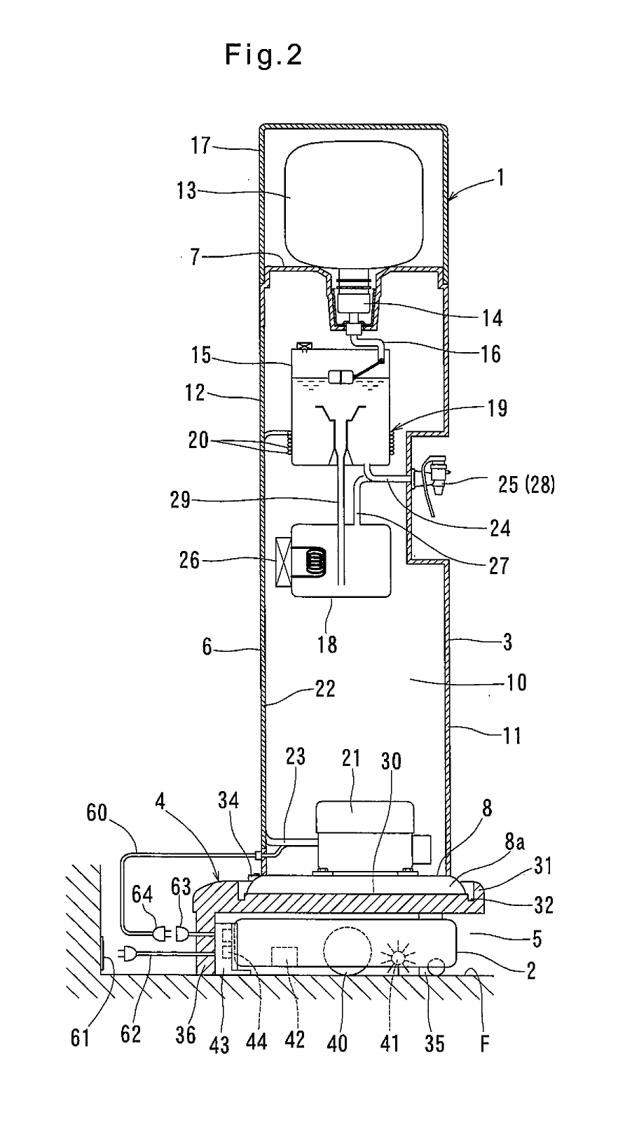

FIG. 2.

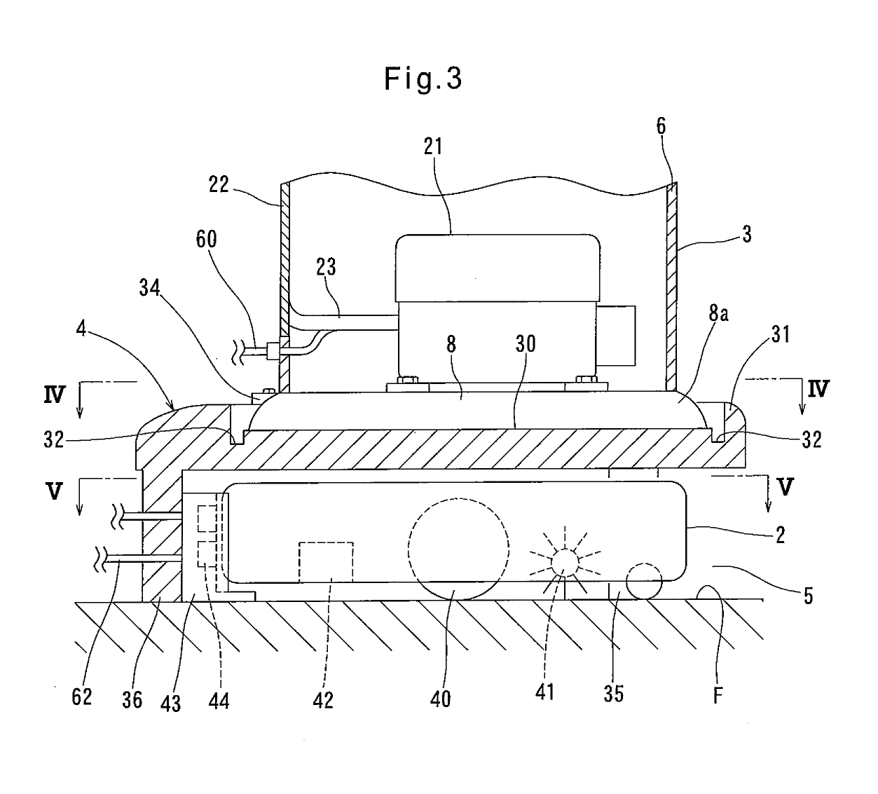

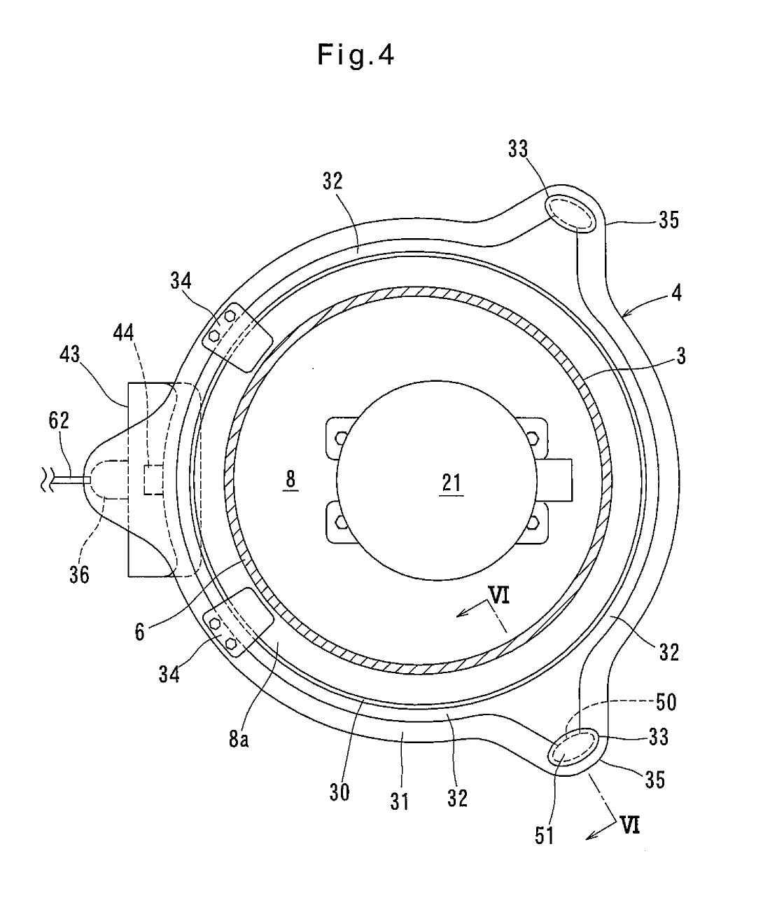

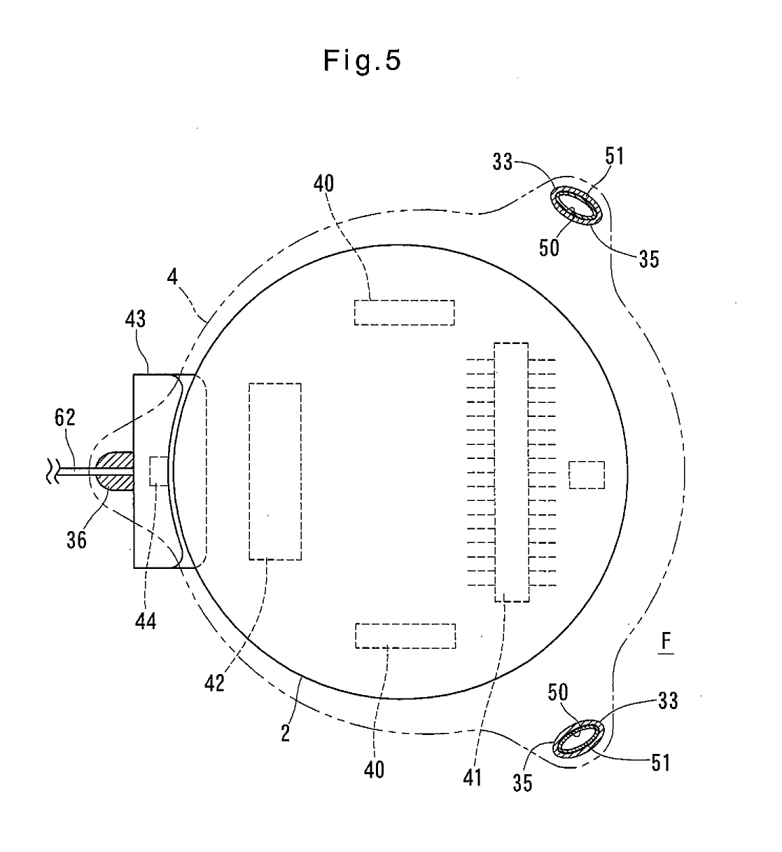

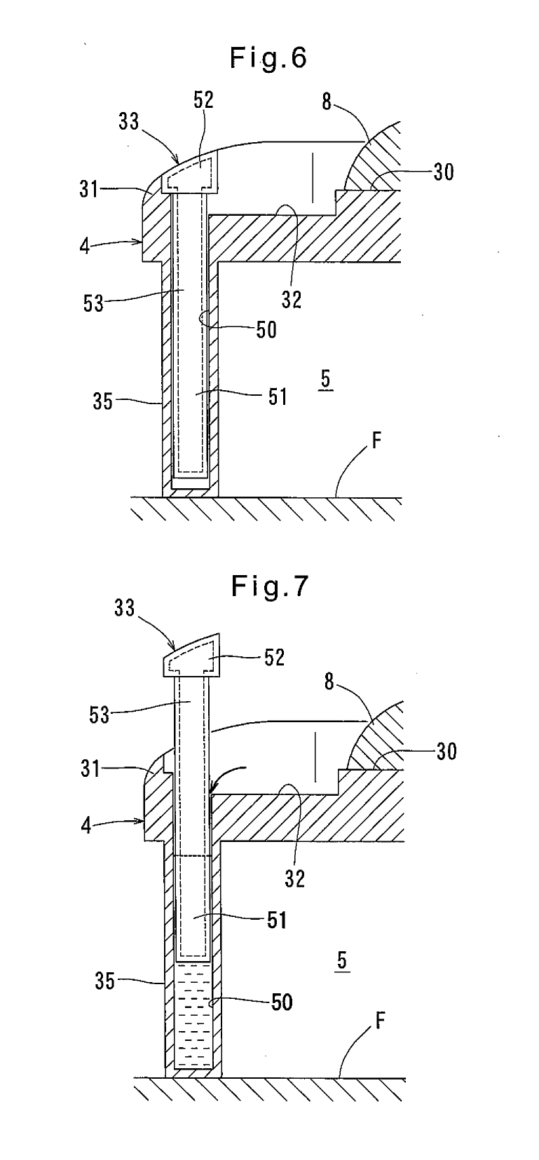

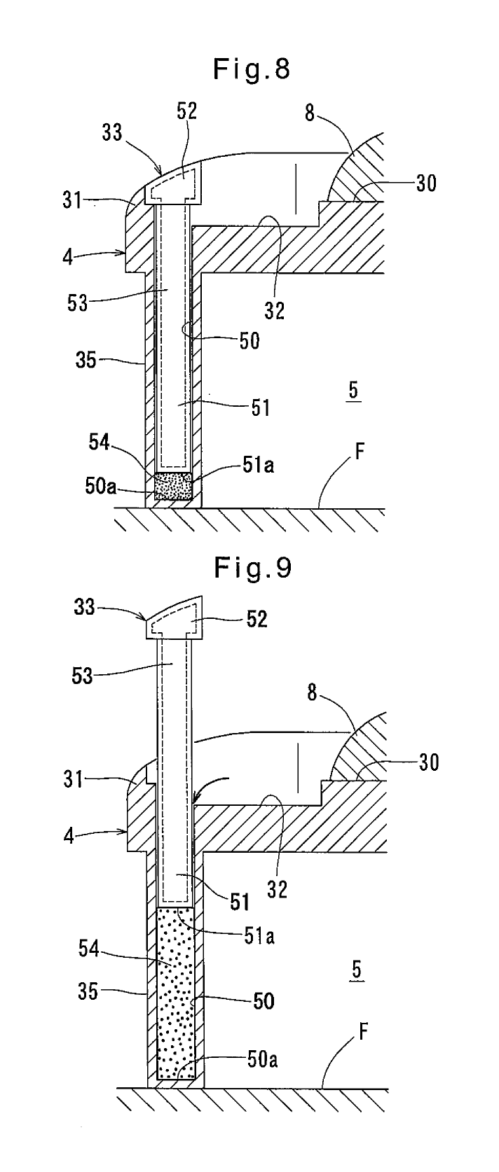

FIG. 4 is a sectional view taken along line IV-IV of FIG. 3.

FIG. 5 is a sectional view taken along line V-V of FIG. 3.

FIG. 6 is an enlarged sectional view taken along line VI-VI of FIG. 4.

FIG. 7 is an enlarged sectional view of a float receiving recess shown in FIG. 6, in which water is in the float receiving recess.

FIG. 8 is an enlarged sectional view showing a modification of a water leakage indicator shown in FIG. 6.

FIG. 9 is an enlarged sectional view of a float receiving recess shown in FIG. 8, in which water is in the float receiving recess.

### BEST MODE FOR EMBODYING THE INVENTION

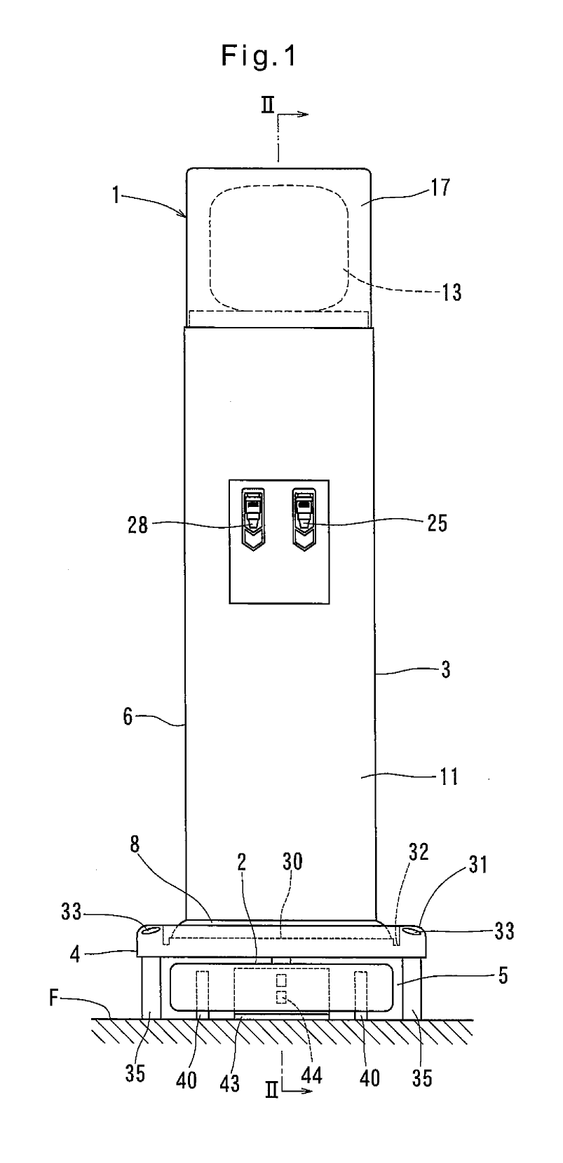

FIG. 1 shows a water dispenser unit comprising a water dispenser 1 embodying the present invention, and a self-propelled cleaning robot 2 capable of cleaning the floor surface by automatically traveling on the floor surface F.

The water dispenser 1 includes a housing 3 arranged over the floor surface F, and a dispenser tray 4 disposed between the bottom end of the housing 3 and the floor surface F and vertically separating the housing 3 from the floor surface F. The self-propelled cleaning robot 2 is capable of autonomously entering and exiting a robot receiving space 5 defined between the dispenser tray 4 and the floor surface F, by travelling on the floor surface F.

As shown in FIG. 2, the housing 3 comprises a vertically extending tubular wall 6, a top panel 7 mounted to the top of the tubular wall 6, and a bottom panel 8 mounted to the bottom of the tubular wall 6. The bottom panel 8 is fixed to the tubular wall 6 by screws, not shown. The tubular wall 6 comprises a right and left pair of side panels 10, a front panel 11 coupling together the front edges of the side panels 10, and a rear panel 12 coupling together the rear edges of the side panels 10. In the embodiment, the tubular wall 6 is a cylindrical member having a substantially circular outer periphery, but it may be in the shape of a rectangular tube having a substantially rectangular outer periphery.

A replaceable raw water container 13 is detachably set on the top panel 7 of the housing 3. The raw water container 13 is placed on the top panel 7 of the housing 3 with its water outlet 14 facing down. The raw water container 13 can hold up to about 8-20 liters of water. The top panel 7 of the housing 3 is provided with a water introducing pipe 16 through which, with the raw water container 13 placed on the top panel 7, water is introduced from the raw water container 13 into a cold water tank 15 inside the housing 3. A cosmetic cover 17 is mounted on the top of the housing 3 to cover the raw water container 13.

Besides the cold water tank 15, in which is stored low-temperature drinking water, the housing 3 houses a hot water tank 18 in which is stored high-temperature drinking water. A cooling device 19 is mounted to the cold water tank 15 to cool drinking water in the cold water tank 15. The cooling device 19 comprises a refrigerant pipe 20 wound around the outer periphery of the cold water tank 15, a compressor 21 fixed to the bottom panel 8 of the housing 3, and a condenser 22 fixed to the rear panel 12 of the housing 3, the refrigerant pipe 20, the compressor 21 and the condenser 22 being connected together by pipes 23. When activated, the compressor 21 cools the refrigerant pipe 20 to about −15° C. to −30° C., thereby cooling drinking water in the cold water tank 15 to low temperature (about 5° C.).

A cold water dispensing pipe 24 is connected to the bottom surface of the cold water tank 15 so that low-temperature drinking water in the cold water tank 15 is dispensed to the outside of the housing 3 through the cold water dispensing pipe 24. The cold water dispensing pipe 24 is provided with a cold water cock 25 operable from outside the housing 3 so that by opening the cold water cock 25, low-temperature drinking water in the cold water tank 15 can be dispensed into e.g., a cup. The cold water cock 25 is provided at the front side of the housing 3 (in other words, the side of the housing 3 where there is the cold water cock 25 is the front side of the housing 3, and its side opposite from the front side is the rear side of the housing 3). The capacity of the cold water tank 15 is smaller than that of the raw water container 13, and about 2-4 liters.

The hot water tank 18 is disposed under the cold water tank 15. A heating device 26 is mounted to the hot water tank 18 to heat drinking water in the hot water tank 18. In FIG. 2, the heating device is a sheath heater, but it may be a band heater. The sheath heater includes a heating wire received in a metal pipe and configured to heat up when energized, and is mounted to the hot water tank 18 to extend through the wall of the hot water tank 18 and in the hot water tank 18. The band heater is a cylindrical heating element in which is embedded a heating wire configured to heat up when energized, and would be mounted to the hot water tank 18 in close contact with the outer periphery of the hot water tank 18. The heating device 26 keeps the drinking water in the hot water tank 18 at high temperature (about 90° C.).

A hot water dispensing pipe 27 is connected to the top surface of the hot water tank 18 so that high-temperature drinking water in the hot water tank 18 is dispensed to the outside of the housing 3 through the hot water dispensing pipe 27. The hot water dispensing pipe 27 is provided with a hot water cock 28 operable from outside the housing 3 so that by opening the hot water cock 28, high-temperature drinking water in the hot water tank 18 can be dispensed e.g., into a cup. As with the cold water cock 25, the hot water cock 28 is provided at the front side of the housing 3. The capacity of the hot water tank 18 is about 1-2 liters.

The cold water tank 15 and the hot water tank 18 communicate with each other through a connecting pipe 29 such that when drinking water is discharged from the hot water tank 18, the same amount of drinking water as the amount of drinking water discharged from the hot water tank 18 flows from the cold water tank 15 into the hot water tank 18 through the tank connecting pipe 29, thereby always filling the hot water tank 18 with drinking water.

As shown in FIGS. 3 and 4, the dispenser tray 4 includes a dispenser support surface 30 on which is supported the housing 3 of the water dispenser 1, a peripheral wall 31 surrounding, as viewed from top, the dispenser support surface 30, a water collecting groove 32 extending between the dispenser support surface 30 and the peripheral wall 31 and along the peripheral wall 31, and two water leakage indicators 33 provided in regions surrounded by the peripheral wall 31.

The dispenser support surface 30 has an area equal to or larger than the area of the bottom panel 8 of the housing 3 of the water dispenser 1 so that the housing 3 can be stably supported on the dispenser support surface 30 when the former is placed on the latter. In the example shown, the dispenser support surface 30 is a horizontal flat surface so that different kinds of housings 3 having bottom panels 8 different in shape from each other can be used.

The peripheral wall 31 has a protruding portion protruding vertically upwardly further than the dispenser support surface 30 and completely surrounding the dispenser support surface 30 without interruption. Thus, if water leaks from the housing 3 with the housing 3 placed on the dispenser support surface 30, the protruding portion is capable of keeping such leaked water inside the peripheral wall 31 until the water level reaches the top edge of the protruding portion.

As shown in FIG. 4, the water collecting groove 32 is, as viewed from top, an annular groove surrounding the bottom panel 8 of the housing 3 of the water dispenser 1. The two water leakage indicators 33 are provided at the front side of the housing 3 and spaced apart from each other in the right-and-left direction. The water collecting groove 32 communicates with the water leakage indicators 33, and is inclined such that its height gradually decreases toward the respective water leakage indicators 33. Specifically, the groove bottom of the water collecting groove 32 is inclined such that the height of the groove bottom gradually decreases from its portion corresponding to the rear center of the dispenser support surface 30 toward the right and left water leakage indicators 33, respectively, and such that the height of the groove bottom gradually decreases from its portion corresponding to the front center of the dispenser support surface 30 toward the right and left water leakage indicators 33, respectively.

The dispenser tray 4 and the housing 3 are fastened together by a fastening means 34 so that the dispenser tray 4 and the housing 3 do not move relative to each other. In this embodiment, the bottom panel 8 of the housing 3 includes a protruding portion 8a protruding outwardly further than the tubular wall 6 of the housing 3. The fastening means 34 comprises presser plates mounted to the peripheral wall 31 of the dispenser tray 4 so as to be located over, and opposed to, the dispenser support surface 30, with the protruding portion 8a of the bottom panel 8 disposed therebetween. The presser plates press down the protruding portion 8a of the bottom panel 8, thereby preventing the movement of the housing 3 relative to the dispenser tray 4.

As shown in FIGS. 3 and 5, the dispenser tray 4 includes a plurality of support legs extending downwardly from positions outside of the dispenser support surface 30 and contacting the floor surface F. The support legs are constituted by a pair of right and left support legs 35 provided at the front side of the housing 3 of the water dispenser 1, and a support leg 36 provided at the rear side of the housing 3. The support legs 35 and 36 are taller than the self-propelled cleaning robot 2 to define the robot receiving space 5 between the dispenser support surface 30 and the floor surface F such that the self-propelled cleaning robot 2 can be received in the robot receiving space 5. Also, the distance between the pair of right and left support legs 35 at the front side of the housing 3 is set to be larger than the width of the self-propelled cleaning robot 2 so that the self-propelled cleaning robot 2 can enter and exit the robot receiving space 5 through the space between the pair of right and left support legs 35 from and to the front side of the dispenser tray 4, while being self-propelled.

The self-propelled cleaning robot 2 includes a travel device 40 which allows the robot 2 to travel on the floor surface F, a dust collecting device 41 for removing dust and trash from the floor surface F, and a built-in rechargeable battery 42 which supplies electric power for driving the travel device 40 and the dust collecting device 41. In this embodiment, the self-propelled cleaning robot 2 is, as viewed from top (see FIG. 5), circular in shape, and has a diameter of 25 to 35 cm. Also, the self-propelled cleaning robot 2 has a height of 5 to 10 cm from the floor surface F to its top surface while the robot 2 is traveling on the floor surface F.

The robot receiving space 5 is provided with a charging station 43 capable of charging the rechargeable battery 42 when the self-propelled cleaning robot 2 is received in the robot receiving space 5. The charging station 43 includes charging terminals 44 positioned such that the terminals 44 contact the self-propelled cleaning robot 2 when the self-propelled cleaning robot 2 enters the robot receiving space 5 while being self-propelled. The charging station 43 is fastened to the support leg 36, which is located at the rear side of the housing 3 of the water dispenser 1, by fastening means (not shown) such as bolts such that they will not move relative to each other.

The vertical width of the robot receiving space 5 is set to be larger by about 0.5 to 5.0 cm than the height of the self-propelled cleaning robot 2. By setting the former value larger by more than 0.5 cm than the latter value, it is possible to reliably prevent the self-propelled cleaning robot 2 from interfering with the dispenser tray 4. By setting the former value larger by less than 5.0 cm than the latter value, the lengths of the support legs 35 and 36 of the dispenser tray 4 can be made sufficiently short to stabilize the position of the housing 3 of the water dispenser 1. In order to minimize the area of the floor surface F occupied by the dispenser tray 4 when placed on the floor surface F, the dispenser tray 4 is sized so as to be entirely received within an imaginary 50-cm square (preferably within a 45-cm square), as viewed from top.

As shown in FIG. 6, the water leakage indicators 33 each include a float receiving recess 50 open to the top surface of the dispenser tray 4 and extending into the corresponding support leg 35, and a water detecting float 51 inserted in the float receiving recess 50. The float receiving recess 50 is closed such that water flowing into the float receiving recess 50 from the water collecting groove 32 never flows out onto the floor surface F. The water detecting float 51 includes a head 52, and a trunk portion 53 extending downwardly from the head 52. While there is no water in the float receiving recess 50, the head 52 of the water detecting float 51 is exposed to outside, while the trunk portion 53 of the water detecting float 51 is hidden in the float receiving recess 50 and not seen from outside.

As a whole, the water detecting float 51 has a specific gravity smaller than water so that, as shown in FIG. 7, when water flows into the float receiving recess 50, the water detecting float 51 rises due to the buoyancy of water. In the figures, the water detecting float 51 is a hollow member having its surface covered with non-foamed resin, but may be entirely formed of foamed resin instead.

The head 52 of the water detecting float 51 has the same color as the surface of the peripheral wall 31 of the dispenser tray 4. On the other hand, the trunk portion 53 of the water detecting float 51 (i.e., the portion that protrudes from the float receiving recess 50 and is exposed to outside when the float 51 rises) has a water leakage alarm color or colors which can notify users of the leakage of water. The water leakage alarm color or colors should be different from the color of the peripheral wall 31 of the dispenser tray 4. For example, if the color of the peripheral wall 31 of the dispenser tray 4 is black, gray, white, light blue, or brown, the water leakage alarm color or colors may be red, yellow, or alternating red and yellow.

The water leakage indicators 33 are each changeable between the water leakage alarm state and the non-water-leakage-alarm state. Specifically, while there is no water in the float receiving recess 50, since the water detecting float 51 is at the lowest position as shown in FIG. 6, the water leakage alarm color or colors of the trunk portion 53 of the water detecting float 51 cannot be seen from outside, that is, the water leakage indicator 33 is in the non-water-leakage-alarm state. As shown in FIG. 7, when water flows into the float receiving recess 50, as shown in FIG. 7, the water detecting float 51 rises due to the buoyancy of water, so that the water leakage alarm color or colors of the trunk portion 53 of the water detecting float 51 becomes visible from outside, that is, the water leakage indicator 33 changes to the water leakage alarm state.

As shown in FIG. 2, the housing 3 of the water dispenser 1 carries a power cord 60 through which electric power is supplied to the cooling device 19, the heating device 26, and a control circuit, not shown, for controlling the cooling device 19 and the heating device 26. The charging station 43 is provided with a power cord 62 connected to a power outlet 61. The charging station 43 further includes a tap 63 which bifurcates from the power cord 62 to supply power. A plug 64 provided at the distal end of the power cord 60 of the water dispenser 1 is connected to the tap 63.

The water dispenser 1 is configured such that if water should leak from the housing 3, the dispenser tray 4, which separates the housing 3 from the floor surface F, receives water so as to prevent leakage of water onto the floor surface F. At that time, the water leakage indicators 33 provided at the dispenser tray 4 change to the water leakage alarm state, thus making it possible to detect water leakage at an early stage. Especially if water leaks from the housing 3 of the water dispenser 1 at a slow rate (such as if a trace amount of water oozes out), leaked water is less likely to be visually recognized, so that it tends to take a long time until water leakage is detected, which in turn tends to cause e.g., corrosion of the floor surface F. Even in such a situation, however, the water dispenser according to the present invention is capable of detecting water leakage at an early stage, thus e.g., preventing corrosion of the floor surface F.

Also, with the water dispenser 1 according to the present invention, since the water collecting groove 32 is provided between the dispenser support surface 30 of the dispenser tray 4 and the peripheral wall 31 so as to communicate with the water leakage indicators 33, water on the dispenser tray 4 can easily reach the water leakage indicators 33 through the water collecting groove 32, which makes it possible to detect water leakage at an early stage.

Further, with this water dispenser 1, since the water collecting groove 32 of the dispenser tray 4 is inclined such that its height gradually decreases toward the respective water leakage indicators 33, water collecting in the water collecting groove 32 is guided to the water leakage indicators 33 due to the inclination of the water collecting groove 32. This allows the water leakage indicators 33 to change to the water leakage alarm state while the amount of water leakage is still small, which in turn makes it possible to detect water leakage at an early stage.

Furthermore, with this water dispenser 1, since the interior spaces of the support legs 35 of the dispenser tray 4 are used to receive the water detecting floats 51, it is possible to increase the lengths of the water detecting floats 51, thus increasing the distances by which the water detecting floats 51 rise due to the buoyancy of water. This increases the lengths of the portions of the water detecting floats 51 protruding from the float receiving recesses 50 when the water detecting floats 51 have risen due to the buoyancy of water, thus making it possible to reliably notify users of water leakage. Also, compared to electric water leakage indicators, the water leakage indicators 33 are simple in structure and thus are less likely to fail, and operate reliably.

Since this water dispenser 1 is capable of receiving the self-propelled cleaning robot 2 between the dispenser support surface 30 and the floor surface F, the water dispenser 1 and the self-propelled cleaning robot 2 take up, in combination, smaller space.

With this water dispenser 1, since the support legs 35 of the dispenser tray 4 are longer than the height of the self-propelled cleaning robot 2 so that the self-propelled cleaning robot 2 can enter and exit, while being self-propelled, the robot receiving space 5 defined between the dispenser support surface 30 and the floor surface F, it is possible to effectively increase the lengths of the water detecting floats 51, which are received in the support legs 35 of the dispenser tray 4.

With this water dispenser 1, since the dispenser tray 4 and the housing 3 are fastened to each other by the fastening means 34 so as not to be movable relative to each other, it is possible to effectively prevent the fall of the housing 3 of the water dispenser 1 even if the housing 3 of the water dispenser 1 is hit by a person or during an earthquake. The water dispenser 1 is thus safe to use.

FIGS. 8 and 9 show a different water leakage indicator 33. Elements shown in these figures that correspond to those of the above embodiment are denoted by identical numerals, and their description is omitted.

A water absorbent polymer member 54 is received in the float receiving recess 50 of this water leakage indicator 33. The water detecting float 51 has a bottom end surface 51a opposed to the inner bottom surface 50a of the float receiving recess 50. The water absorbent polymer member 54 is disposed between the bottom end surface 51a of the water detecting float 51 and the inner bottom surface 50a of the float receiving recess 50. The water absorbent polymer member 54 is made of a water absorbent polymer capable of expanding to 100 times or more of its own weight by absorbing water. Such water absorbent polymers include sodium polyacrylate.

As with the above embodiment, this water leakage indicator 33 also changes between the water leakage alarm state and the non-water-leakage-alarm state. Specifically, while there is no water in the float receiving recess 50, since the water detecting float 51 is at the lowest position as shown in FIG. 8, the water leakage alarm color or colors of the trunk portion 53 of the water detecting float 51 cannot be seen from outside, that is, the water leakage indicator 33 is in the non-water-leakage-alarm state. When water flows into the float receiving recess 50, as shown in FIG. 9, the water absorbent polymer member 54 expands in the float receiving recess 50 by absorbing water, thereby pushing up the bottom end surface 51a of the water detecting float 51. As a result, the water detecting float 51 rises, so that the water leakage alarm color or colors of the trunk portion 53 of the water detecting float 51 becomes visible from outside, that is, the water leakage indicator 33 changes to the water leakage alarm state.

Since the water leakage indicator 33 shown in FIGS. 8 and 9 is configured to raise the water detecting float 51 using the expansion force of the water absorbent polymer member 54, it is possible to raise the water detecting float 51 by a longer distance than when raising the water detecting float 51 using the buoyancy of water. Thus, when the water detecting float 51 is raised by the water absorbent polymer member 54, the water detecting float 51 protrudes by a long distance from the float receiving recess 50, so that the water leakage indicator 33 can reliably notify user of water leakage.

In the above embodiment, the water leakage indicators 33 include water detecting floats. However, water leakage indicators 33 of a different type may be used. For example, water leakage indicators 33 may be used which is made from a material whose color changes when they get wet with water.

In the above embodiment, the water dispenser 1 is of the type in which drinking water is introduced into the cold water tank 15 from the replaceable raw water container 13. However, the present invention is also applicable to a water dispenser of the type in which drinking water is introduced into the cold water tank 15 from the public water supply through a water purifying filter.

### DESCRIPTION OF THE NUMERALS

1. Water dispenser
2. Self-propelled cleaning robot
3. Housing
4. Dispenser tray
5. Robot receiving space
15. Cold water tank
19. Cooling device
25. Cold water cock
30. Dispenser support surface
31. Peripheral wall
32. Water collecting groove
33. Water leakage indicator
34. Fastening means
35. Support leg
50. Float receiving recess
51. Water detecting float
53. Trunk portion
54. Water absorbent polymer member
F. Floor surface

1. A water dispenser comprising a housing configured to be arranged over a floor surface, a cold water tank received in the housing, a cooling device for cooling drinking water in the cold water tank, a cold water cock for dispensing drinking water in the cold water tank to outside, and a dispenser tray disposed between the housing and the floor surface and vertically separating the housing from the floor surface,
wherein the dispenser tray comprises a dispenser support surface on which the housing is supported, a peripheral wall surrounding the dispenser support surface, and a water leakage indicator disposed in a region surrounded by the peripheral wall, and configured to change between a water leakage alarm state and a non-water-leakage-alarm state depending on whether or not there is water.

2. The water dispenser of claim 1, wherein the dispenser tray further comprises a water collecting groove extending between the dispenser support surface and the peripheral wall, along the peripheral wall, wherein the water leakage indicator communicates with the water collecting groove.

3. The water dispenser of claim 2, wherein the water collecting groove is inclined such that a height of the water collecting groove gradually decreases toward the water leakage indicator.

4. The water dispenser of claim 1, wherein the dispenser tray further comprises support legs extending downwardly from positions outside of the dispenser support surface and contacting the floor surface.

5. The water dispenser of claim 4, wherein the water leakage indicator includes a float receiving recess which opens to a top surface of the dispenser tray and extends into one of the support legs; and a water detecting float inserted in the float receiving recess such that when water enters the float receiving recess, the water detecting float rises due to buoyancy of the water in the float receiving recess, wherein the water detecting float has a portion arranged to protrude from the float receiving recess and be exposed to outside when the water detecting float rises due to the buoyancy of the water in the float receiving recess, said portion having a water leakage alarm color.

6. The water dispenser of claim 4, wherein the water leakage indicator includes a float receiving recess which opens to a top surface of the dispenser tray and extends into one of the support legs; a water absorbent polymer member made of a water absorbent polymer and received in the float receiving recess so as to be expandable by absorbing water; and a water detecting float inserted in the float receiving recess such that when water enters the float receiving recess, the water detecting float is pushed up by the water absorbent polymer member, wherein the water detecting float has a portion arranged to protrude from the float receiving recess and be exposed to outside when the water detecting float is pushed up by the water absorbent polymer member, said portion having a water leakage alarm color.

7. The water dispenser of claim 4, wherein the support legs have lengths larger than a height of a self-propelled cleaning robot so that the support legs define, between the dispenser support surface and the floor surface, a robot receiving space that the self-propelled cleaning robot enters and exists while being self-propelled.

8. The water dispenser of any of claims 1 to 7 claim 1, wherein the dispenser tray and the housing are fastened to each other by a fastening means arrangement so as to be immovable relative to each other.

9. A dispenser tray for a water dispenser, comprising a dispenser support surface on which a housing of the water dispenser can be supported, a peripheral wall surrounding the dispenser support surface, a water leakage indicator disposed in a region surrounded by the peripheral wall, and configured to change between a water leakage alarm state and a non-water-leakage-alarm state depending on whether or not there is water.

10. The water dispenser of claim 2, wherein the dispenser tray further comprises support legs extending downwardly from positions outside of the dispenser support surface and contacting the floor surface.

11. The water dispenser of claim 3, wherein the dispenser tray further comprises support legs extending downwardly from positions outside of the dispenser support surface and contacting the floor surface.

12. The water dispenser of claim 10, wherein the water leakage indicator includes a float receiving recess which opens to a top surface of the dispenser tray and extends into one of the support legs; and a water detecting float inserted in the float receiving recess such that when water enters the float receiving recess, the water detecting float rises due to buoyancy of the water in the float receiving recess, wherein the water detecting float has a portion arranged to protrude from the float receiving recess and be exposed to outside when the water detecting float rises due to the buoyancy of the water in the float receiving recess, said portion having a water leakage alarm color.

13. The water dispenser of claim 11, wherein the water leakage indicator includes a float receiving recess which opens to a top surface of the dispenser tray and extends into one of the support legs; and a water detecting float inserted in the float receiving recess such that when water enters the float receiving recess, the water detecting float rises due to buoyancy of the water in the float receiving recess, wherein the water detecting float has a portion arranged to protrude from the float receiving recess and be exposed to outside when the water detecting float rises due to the buoyancy of the water in the float receiving recess, said portion having a water leakage alarm color.

14. The water dispenser of claim 10, wherein the water leakage indicator includes a float receiving recess which opens to a top surface of the dispenser tray and extends into one of the support legs; a water absorbent polymer member made of a water absorbent polymer and received in the float receiving recess so as to be expandable by absorbing water; and a water detecting float inserted in the float receiving recess such that when water enters the float receiving recess, the water detecting float is pushed up by the water absorbent polymer member, wherein the water detecting float has a portion arranged to protrude from the float receiving recess and be exposed to outside when the water detecting float is pushed up by the water absorbent polymer member, said portion having a water leakage alarm color.

15. The water dispenser of claim 11, wherein the water leakage indicator includes a float receiving recess which opens to a top surface of the dispenser tray and extends into one of the support legs; a water absorbent polymer member made of a water absorbent polymer and received in the float receiving recess so as to be expandable by absorbing water; and a water detecting float inserted in the float receiving recess such that when water enters the float receiving recess, the water detecting float is pushed up by the water absorbent polymer member, wherein the water detecting float has a portion arranged to protrude from the float receiving recess and be exposed to outside when the water detecting float is pushed up by the water absorbent polymer member, said portion having a water leakage alarm color.

16. The water dispenser of claim 5, wherein the support legs have lengths larger than a height of a self-propelled cleaning robot so that the support legs define, between the dispenser support surface and the floor surface, a robot receiving space that the self-propelled cleaning robot enters and exists while being self-propelled.

17. The water dispenser of claim 6, wherein the support legs have lengths larger than a height of a self-propelled cleaning robot so that the support legs define, between the dispenser support surface and the floor surface, a robot receiving space that the self-propelled cleaning robot enters and exists while being self-propelled.
